(19) United States
(12) Patent Application Publication
(10) Pub. No.: US 2024/0087766 A1
(43) Pub. Date: Mar. 14, 2024

(54) RADIOISOTOPE GENERATOR, APPARATUS, SYSTEM AND METHOD

(71) Applicant: NU PLANET PHARMACEUTICAL RADIOISOTOPES, INC., Scottsdale, AZ (US)

(72) Inventors: Steven Daniel HOWE, Phoenix, AZ (US); Troy Michael HOWE, Scottsdale, AZ (US); Dereck Neill ARMSTRONG, Johannesburg (ZA); Thomas Howard Myers, Marietta, GA (US)

(73) Assignee: NU PLANET PHARMACEUTICAL RADIOISOTOPES, INC, Scottsdale, AZ (US)

(21) Appl. No.: 17/931,078

(22) Filed: Sep. 9, 2022

Related U.S. Application Data
(60) Provisional application No. 63/261,054, filed on Sep. 9, 2021.
(60) Provisional application No. 63/261,748, filed on Sep. 28, 2021.
(60) Provisional application No. 63/261,750, filed on Sep. 28, 2021.
(60) Provisional application No. 63/261,753, filed on Sep. 28, 2021.
(60) Provisional application No. 63/261,757, filed on Sep. 28, 2021.
(60) Provisional application No. 63/264,525, filed on Nov. 24, 2021.
(60) Provisional application No. 63/264,527, filed on Nov. 24, 2021.
(60) Provisional application No. 63/264,529, filed on Nov. 24, 2021.
(60) Provisional application No. 63/264,535, filed on Nov. 24, 2021.
(60) Provisional application No. 63/264,537, filed on Nov. 24, 2021.
(60) Provisional application No. 63/269,936, filed on Mar. 25, 2022.
(60) Provisional application No. 63/269,938, filed on Mar. 25, 2022.

(51) Int. Cl. G21G 1/12; G21F 9/06; G21H 1/12

(52) U.S. Cl. CPC G21G 1/12; G21F 9/06; G21H 1/12

(57) ABSTRACT

A radioisotope generator including a laser, a volume of target isotope, and nanoparticles in a solid, liquid, or gas state is provided. In at least one aspect, the radioisotope generator accelerates the decay rate of an isotope, with the laser being used to accelerate the decay of the isotope for the production of desired product isotopes.

### CROSS-REFERENCE TO RELATED APPLICATIONS

The present application claims the benefit of U.S. Provisional Patent Application No. 63/261,054, filed Sep. 9, 2021, U.S. Provisional Patent Application No. 63/261,748, filed Sep. 28, 2021. U.S. Provisional Patent Application No. 63/261,750, filed Sep. 28, 2021, U.S. Provisional Patent Application No. 63/261,753, filed Sep. 28, 2021, U.S. Provisional Patent Application No. 63/261,757, filed Sep. 28, 2021, U.S. Provisional Patent Application No. 63/264,525, filed Nov. 24, 2021, U.S. Provisional Patent Application No. 63/264,527, filed Nov. 24, 2021. U.S. Provisional Patent Application No. 63/264,529, filed Nov. 24, 2021, U.S. Provisional Patent Application No. 63/264,535, filed Nov. 24, 2021. U.S. Provisional Patent Application No. 63/264,537, filed Nov. 24, 2021. U.S. Provisional Patent Application No. 63/269,936, filed Mar. 25, 2022, and U.S. Provisional Patent Application No. 63/269,938, filed Mar. 25, 2022, the entire contents of each of which are incorporated herein by reference as if repeated in their entirety herein.

### FIELD OF THE INVENTION

The present disclosure pertains generally to the acceleration of the decay rate of any isotope, and, in at least one exemplary embodiment, to the use of lasers to accelerate the decay of a selected isotope for the production of desired product isotopes. In at least one aspect, this disclosure outlines configurations of a system with a number of unique features to achieve isotope production.

### BACKGROUND OF THE INVENTION

Various isotopes have proven to be valuable and useful, for example, in applications in the healthcare, engineering/industrial, energy and space power fields. As an example, within healthcare, multiple isotopes are constituent ingredients in pharmaceuticals, including those used for imaging and therapeutic purposes. The production and supply of isotopes for these and other applications are limited by and although research to increase availability and reduce costs for users has been pursued, options remain limited. For example, the US Department of Energy's NIDC (National Isotope Development Center) coordinates efforts across multiple nuclear laboratories to provide several of these industries with a range of isotopes.

### SUMMARY

In one aspect, the present disclosure utilizes a method for accelerating the rate of decay of a targeted isotope, in at least one exemplary application, for the purpose of increasing the production rate of daughter isotopes that are formed from the target isotope's decay.

This exemplary approach induces and accelerates nuclear excitations at achievable peak laser intensity levels. The laser beam interacts with conductive nanoparticles and/or nanostructures in close proximity of the targeted atoms. This interaction causes resonance conditions of the charge carriers in the nanoparticles or nanostructures, which can enhance the field intensity by factors of 10⁶-10⁸. These substantial field increases in the laser radiation reach levels required to induce nuclear activity in the atoms exposed to these fields. In the present disclosure, this methodology is discussed and applied for the purpose of producing radioisotopes. In at least one exemplary embodiment, this configuration enables effective, scalable production of various isotopes.

This accelerated decay method can be combined with known radiochemical separation processes to separate and isolate desirable, high-value isotopes from the by-products of the accelerated decay process. Radioisotopes produced with this method can be used in fields including, but not limited to, pharmaceuticals, medical imaging and therapy, energy production, industrial sensors and military applications.

### BRIEF DESCRIPTION OF DRAWINGS

FIG. 1 shows an exemplary schematic of a radioisotope generator.

FIG. 2 shows an exemplary method of Surface Plasmon Resonance.

FIG. 3 shows the radioisotope generator of FIG. 1 including a laser, beam control optics, a lens, and a solution of a target isotope mixed with nanoparticles in suspension.

FIG. 4 shows a table of examples of target isotopes as raw materials to generate the desired daughter isotopes using the radioisotope generator of FIG. 1.

### DETAILED DESCRIPTION

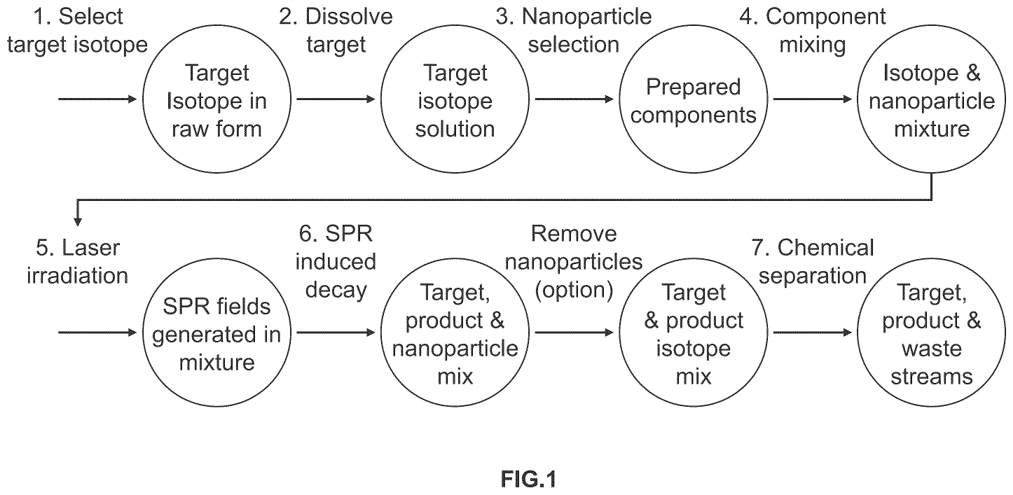

In at least one aspect, exemplary embodiments of the present disclosure pertain to systems, apparatus, and methodologies for producing various isotopes. The isotope production in at least one aspect of the present disclosure is enabled by using a laser system to irradiate target isotopes, the raw-materials in this process, in the presence of conductive nanoparticles. The function of the nanoparticles is described in more detail below. In these exemplary embodiments, specific target isotopes (also sometimes referred to as parent isotopes) are irradiated to produce desired product isotopes (also sometime referred to as daughter isotopes), the steps of this exemplary process are laid out in FIG. 1 and detailed below.

Through this exemplary method of laser irradiation in the presence of conductive nanoparticles, the natural decay rate of the target isotope is temporarily accelerated, transmuting atoms of the target isotope into atoms of the desired daughter isotopes. The resulting solution after the irradiation contains a mixture of elements including a fraction of the target isotope that has not transmuted, a fraction of the desired product isotope and fractions of other by-product isotopes. Following this process, known methods of chemical separation can be used to separate and purify desired products from the mixture of isotopes left after laser irradiation.

### Surface Plasmon Resonance and the Role of the Nanoparticles

In at least one aspect of the present disclosure, accelerating the decay of target isotopes is used as a method of producing desired daughter isotopes, as described above. Accelerated decay is achieved by exposing the target isotopes to an electric field of an intensity large enough to induce nuclear excitations, increasing the probability and rate of nuclear decay. In the present disclosure, these electric fields are generated using a high intensity laser beam which interacts with specifically selected nanoparticles to cause Surface Plasmon Resonance (SPR), which is a scientific phenomenon that arises when light photons travel across the surface of a conducting material (e.g., gold, platinum and other materials) and induce oscillations in the electrons (charge carriers) within the conducting material. The oscillation of these electrons produces large electric fields near the surface of the material that can have intensities 10⁶-10⁸ times greater than the intensity of the laser. SPR is a phenomenon utilized extensively in fields, such as biomedical research.

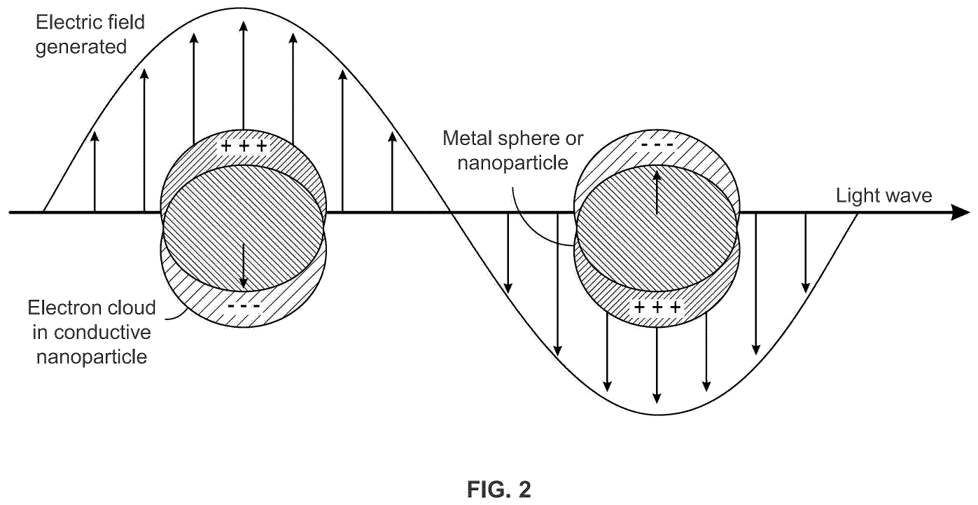

In at least one aspect, the basis for SPR is described and graphically illustrated in FIG. 2. As a photon passes the nanoparticle, the photon's electric field causes the electron cloud in the particle to oscillate, behaving somewhat like an incompressible fluid. If the nanoparticle is chosen correctly, the photon wave will resonate with the electron cloud amplifying the electric field and creating large electric fields within short distances (˜100 nm) of the nanoparticle's surface.

SPR was originally observed in solid or layered conductive materials. The advent of metallic nanoparticle fabrication has added the potential of creating resonance conditions in conductive nanoparticles exposed to a photon beam such as a laser. This advancement enables the generation of the SPR phenomenon using conductive nanoparticles in suspension within a solution of target isotopes. This configuration ensures that when the target isotopes in solution are close enough to the nanoparticles to experience the intense electric fields generated by the SPR phenomenon and induce nuclear excitations.

However, in order to create the resonant conditions of SPR, the laser wavelength must be matched to the nanoparticle size and material. The relationship between these parameters and their suitability to create resonant conditions for SPR are documented and represented in a field known as Mie Theory, aiding laser and nanoparticle selection in embodiments of the present disclosure.

### Components of an Exemplary Embodiment

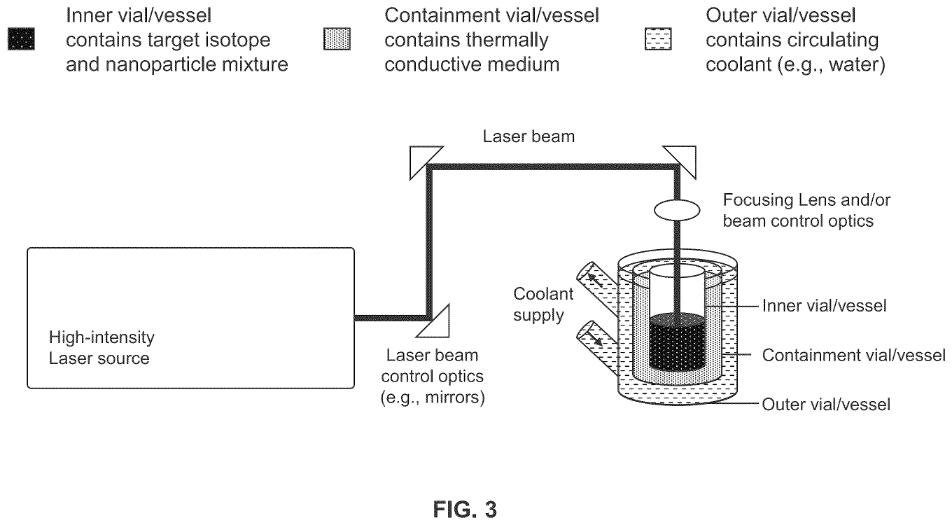

An exemplary physical configuration of the present disclosure is represented in FIG. 3. In one exemplary embodiment, the process includes five components:
A laser: The laser is used as the input of energy and power into the system and drives the process downstream nuclear excitations. Laser intensity (power over per unit area) is a key factor in the selection of the laser to use. To drive the process, in at least one exemplary embodiment, a field intensity of >10⁸ W/cm² is required. This intensity can be achieved directly with the laser system, where the beam intensity is calculated from the beam area (cm²), pulse energy (Joules) and pulse duration (seconds). If a focusing lens is used, then the beam intensity calculated should take into account the impact of the focusing on the intensity at the focal point of the lens can achieve intensities of >10⁸ W/cm² at the focal point while using a laser where the intensity is <10⁸ W/cm² before the lens. Thus, laser selection and the use of a lens primarily aims to maximize intensity (power per unit area, e.g., W/cm²) while also maximizing the area (cm²) experiencing the high intensity.

Laser wavelength is another factor in laser selection, viable wavelengths may cover the UV (100 nm-360 nm), visible (360 nm-830 nm), and IR (830 nm-1 mm) bands. Laser wavelength is coupled to nanoparticle size and material according to Mie Theory to ensure the occurrence of the SPR effect, as described above. For many of the laser wavelengths in these ranges there are suitable nanoparticles with specific size and material that will generate the SPR effect and so could be used in an exemplary embodiment of the present disclosure.

When selecting a laser for the system both pulsed lasers and continuous wave lasers can be considered as the laser source for the radioisotope generator. Pulsed lasers require a power density (W/cm²) of >10⁸ W/cm² as stated above, or a lens is used to achieve this intensity. Similarly, continuous wave (CW) lasers are also suitable if their total energy deposition is commensurate with the levels of the pulsed laser.

Optics: The laser source described above will produce a straight beam of light as common with lasers. This beam is then directed to the target using optics, such as mirrors, to achieve the desired direction and angle to hit the target.

In one exemplary embodiment, the beam may not use optics to divert and redirect the beam, but would be fired directly through the wall of the vial into the solution. This approach is viable so long as the vial material is selected to ensure that the laser beam does not damage or break the vial.

In another exemplary embodiment, the beam is directed using three separate mirrors so that the beam is firing vertically down into the vial or vessel carrying the target solution. This particular exemplary optical arrangement is graphically represented in FIG. 3.

In another exemplary embodiment, a galvo scanner is used to manipulate the beam to move in a controlled way to fire into the target at different locations. A galvo scanner is optical equipment that moves a mirror at a set speed and angle so that the laser beam is rapidly redirected. This exemplary embodiment using a galvo scanner enables the use of increased repetition rates to tire the beam into a larger area of the target solution over the run time of the laser irradiation.

In the exemplary embodiments, the arrangement aims to ensure that the laser is fired into the solution with minimal obstruction and that the equipment and apparatus are not damaged by the laser.

As mentioned above, the laser beam may also be directed through a selected lens to increase power density at a focal point or to divert the laser output in a specific direction onto the target. The lens may or may not be necessary to achieve the desired power density as lasers with suitable characteristics without an external lens may forego this component. These optics (e.g., mirrors, galvo scanners, lenses) can be independent of the laser and the vial/container or integrated into the laser head or container.

Vial/vessel: The purpose of the vial or vessel is to safely contain the target and nanoparticle mixture during irradiation and for transport into and out of the irradiation location. There are a vast number of embodiments and variations of container that can carry the mixed target solution and nanoparticles. Factors such as heat resistance, depth, handling convenience, seal etc. may be considered to improve the operational ease and safety of the apparatus.

In the exemplary embodiment of FIG. 3 there are multiple vials in order to provide a level of containment and cooling to the inner vial holding the target solution. The vial may be open or sealed, and transparent or opaque assuming there is some window or other aperture available to allow the beam to pass into the solution.

The vial/vessel may include reflective, refractive, or other beam influencing components, included but not limited to: concave/convex mirrors, blackbody cavity assembly, resonance chamber assembly, spigots or spouts to account for splashing or evaporation, mixers, shakers, and other mechanisms to ensure a consistent mixture of the solution.

Target isotope solution—In one exemplary embodiment, target isotope material is dissolved into solution with an acid, such as nitric acid. Water or various acids can be used to create the solutions and may be selected based on the properties that they hold for efficient chemical separation after irradiation.

Creating this liquid solution also provides a medium in which to mix the selected nanoparticles, mentioned above. This exemplary method ensures that volumes of the target isotope are in close proximity to the nanoparticles, and close to enough, within 100 nm, to experience the fields generated by SPR. In a liquid or medium the target isotope may be stirred or mixed to keep the nanoparticles and isotope atoms in close proximity.

Methods to include the target isotope without dissolving may include suspending it in a solid transparent matrix such as sapphire, glass, quartz, alumina, diamond, or other material assuming the geometry and components are able to maintain the necessary positions and distributions.

Nanoparticles in suspension in the target isotope solution: Nanoparticles of different materials, including gold, platinum, silicon, silicon dioxide, silver, aluminum, nickel, copper, CuO, TiO2, and cobalt can be appropriate to create the desired SPR effect when interacting with the laser beam. The specific material and size selected should be commensurate with Mie Theory to produce the resonating conditions and electric fields of SPR as stated above.

Nanoparticle density in the solution can be varied to optimize intensity, extinction length and interaction counts. These factors will influence total isotope production in a given period or irradiation. Nanoparticle densities or concentrations in the range of 0.001 milligrams per milliliter up to 10 milligrams per milliliter of target isotope solution have been shown to produce the SPR effect and can induce and accelerate decay in the surrounding target isotopes

Exemplary Description of the Method of the Present Disclosure

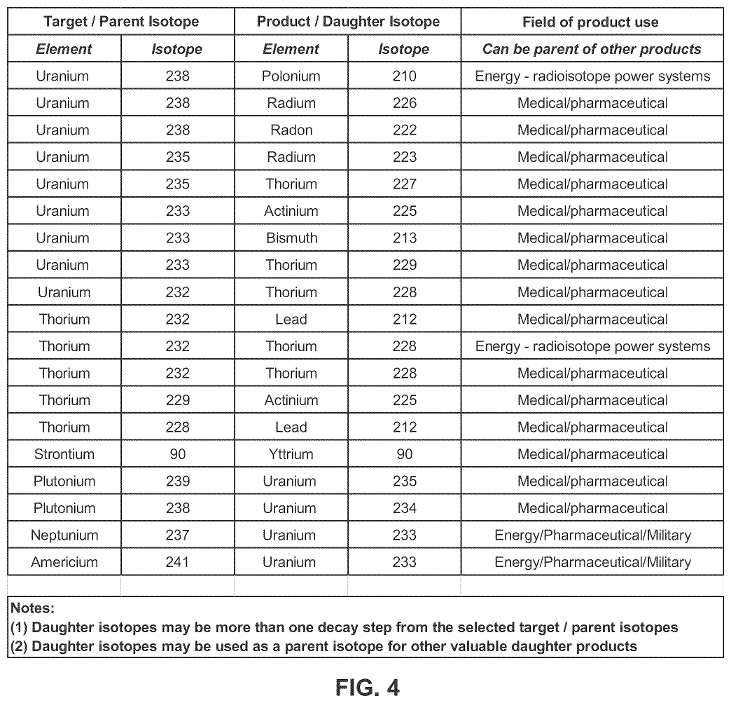

One exemplary process is shown at a high level in FIG. 1. In at least one aspect, the present disclosure includes, in an exemplary embodiment, the following steps:
1. Selection of target parent isotopes: In order to produce a desired isotope, a specific parent isotope is chosen which are parents of the desired isotopes in the decay chain. These parent isotopes are the input raw material to the process. As an example, Uranium-233 might be chosen to produce Thorium-229 or Actinium-255 as both of these isotopes are below Uranium-233 in its decay chain. Potential target isotopes include those which have longer half-lives than their desired daughter products. A non-exhaustive table showing examples of parent and daughter isotope combinations that can be used for selecting target isotopes for this process is shown in FIG. 4.
2. Dissolve target isotope: The selected target isotope may be received in various states (e.g., as a salt, in solution or other forms) from commercial suppliers. In one exemplary embodiment, the target isotope is dissolved in solution of water or various acids. There are multiple acids which can be used including, but not limited to, nitric acid and hydrochloric acid.
   The selection of specific acids for the creation of solutions may be driven by the impact of this selection on the efficacy of the subsequent chemical separation processes for isolating isotope products. In another exemplary embodiment, the target isotopes may be held in a solid form, within a matrix or structure that also comprises of the nanoparticles or nanostructures used to generate the SPR phenomenon
3. Nanoparticle selection: The specific size, material and concentration of nanoparticles used in the radioisotope generator process are selected to maximize the efficacy and occurrence of the SPR phenomenon as described above. This is achieved by matching the laser wavelength, nanoparticle material and size according to Mie Theory.
   In at least one exemplary embodiment of the present disclosure, 20 nanometer gold particles are selected for use with a laser of wavelength within the green light wavelength range (500-565 nm). In at least one exemplary embodiment of the present disclosure, nanoparticles of 20 nm average diameter are used, however, nanoparticles of various sizes may be appropriate for use in the present disclosure, matched with various laser wavelengths
4. Target component mixture: In at least one exemplary embodiment, to prepare to induce and accelerate the radioactive decay of the target isotope, a vial (or other vessel) is filled with a mixture of the target isotopes in solution and the selected nanoparticles in suspension in this solution. This combining or mixing process aims to achieve a planned nanoparticle distribution that will maximize the occurrence of the SPR phenomenon and result in the largest number of transmutations of target isotope atoms to daughter isotopes. Nanoparticle densities in the range of 0.001 milligrams per milliliter up to 10 milligrams per milliliter of target isotope solution have been shown to enable positive accelerated decay results. In at least one exemplary result of the method, gold nanoparticles of 15 nm were used with a concentration of 0.93 mg/ml in a solution of Thorium Nitrate, where the target isotope Thorium-232 was dissolved in solution with nitric acid at a Thorium concentration of 1.84 g/ml. In this exemplary test of the method, the target solution was irradiated for 4 hours and then measured using a High Purity Germanium (HPGe) detector, showing acceleration of decay and an increase in the population of the daughter isotopes of 46% vs. the population prior to irradiation.
5. Laser irradiation: The selected laser is run with the beam directed into the combined isotope and nanoparticle solution, as described above. To maximize isotope production, the volume of the mixture exposed to the laser beam is maximized. Run time can be varied to increase production of daughter isotopes. In exemplary testing of the method laser irradiation took place over 4 hour run times to demonstrate the method. Production run time is increased to transmute increased amounts of the target isotope to daughter isotope products.
   In one exemplary embodiment, where a pulsed laser is used, the repetition rate of the laser can be adjusted to further increase isotope production rate. Repetition rates of 1 Hz-5 Hz were used in exemplary testing of the method. Repetition rates outside of this range will also be feasible as generally increased repetition rate (pulses per second) further increases the production of daughter isotopes. Depending on design and operating mode of the apparatus, increasing repetition rates may also increase risk of overheating and/or damage to apparatus which will then decrease production rates.
6. Laser interaction with nanoparticles: In one exemplary embodiment, during the laser run time the photons of the pulsed laser beams hit the nanoparticles suspended in the solution containing the target isotope and caused the SPR effect, generating electric fields around the nanoparticles 10⁶-10⁸ times larger than the field intensity of the laser itself. These electric fields have the effect of inducing rapid decay of the target isotopes in close vicinity to the nanoparticles (e.g., losing an alpha or beta particle), transmuting these isotopes into daughter isotopes as described above.
   When laser and nanoparticles are selected correctly as described, the SPR effect will be created from the start of irradiation, and run times can be increased to increase isotope production.
7. Chemical separation: At the end of the runtime, the laser is turned off and the vial of solution is then subjected to a chemical separation process whereby the nanoparticles are separated out of the solution, and the desired radioisotopes in the blended solution are separated, e.g., for example, by means of chromatography or other separation techniques.
   In at least one exemplary process, the increased populations of desirable daughter isotopes are purified further as the valuable output products of the process. Other material left over from the process can be recycled to be further processed, or disposed of as waste.

### Using the Invention to Produce Valuable Isotopes

As mentioned above, the present radioisotope generator can produce isotopes which are useful in fields including pharmaceuticals, medical imaging and therapy, energy production, industrial sensors and military applications.

One exemplary application of the present disclosure involves production of isotopes for use in pharmaceuticals for cancer therapy. The radioisotope generator described herein can be used, for example, for the production of the isotope Actinium-225, which is an input ingredient in a form of cancer therapy called Targeted Alpha Therapy. Generally, other production routes for Actinium-225 are a by-product of nuclear fission in a nuclear reactor. In at least one exemplary embodiment, the present disclosure can be used as a fundamentally new approach to producing Ac-225. The following target isotopes could be used to produce Actinium-225: Neptunium-237, Uranium-233, Thorium-229, Radium-225.

As mentioned above, inducing and accelerating decay of a target isotope will result in a mixture of isotopes after the laser irradiation that could include a fraction of the target isotope that has not transmuted, a fraction of the desired product isotope and fractions of other by-product isotopes. Following this process, known methods of chemical separation can be used to separate and purify desired products from the mixture of isotopes left after laser irradiation. In one exemplary process, where Uranium-233 is used as the target isotope, the resulting mixture may include fractions of isotopes including Uranium-233, Thorium-228, Radium-225 and Actinium-225. This mixture can then be separated using known chemical separation methods to achieve various levels of concentration of the Actinium-225 product suitable for supply to pharmaceutical companies.

Examples of target isotopes and the associated product isotopes which are known to be of value are shown in FIG. 4. There are more than 3000 known radioisotopes which could feasibly be considered as in target isotopes or daughter isotope products from the present disclosure.

### Further Applications

In at least one aspect of the present disclosure, the radioisotope generator system induces and accelerates decay of target isotopes to produce quantities of daughter isotopes. This process has two additional obvious additional applications which are being developed include:
(1) The transmutation of unwanted target isotopes by accelerated radioactive decay. The decay of highly radioactive waste materials of various isotopes can be accelerated, releasing energy from these isotopes and transmuting them towards stability. These stable daughter products are less hazardous as they are less radioactive. In at least one exemplary embodiment of the present disclosure this system could process nuclear waste from nuclear fission or fusion plants.
(2) The release of energy from the target isotopes in the form of radioactive decay. The induced and accelerated decay process also releases substantial energy from the target isotope. This energy can be captured for conversion into heat and/or electricity utilizing common thermal power generation equipment such as a steam turbine or a thermocouple. In at least one exemplary embodiment of the present disclosure this system could be used to generate usable electric power.

### DEFINITIONS OF TERMS

For exemplary purposes only and without limiting the foregoing, the following exemplary definitions are provided generally.
Isotope forms of the same element that contain equal numbers of protons but different numbers of neutrons in their nuclei, and hence differ in relative atomic mass.
Radioisotope—an unstable isotope of an element which releases radiation as it breaks down and becomes more stable. Radioisotopes are a subset of all isotopes.
Target Isotope—An isotope selected as the raw material to be transmuted to a series of known daughter isotopes that may the desired product of the process.
Parent Isotope—An isotope that loses energy or mass as part of a decay event and in doing so changes its makeup to become a daughter isotope. In this process, the target isotopes are also parent isotopes as both are decaying to their daughter products.
Daughter Isotope—An isotope produced by the decay of a parent isotope, this decay process can happen at the fixed, natural decay rate or can be caused to accelerate by targeting a parent isotope to induce decay.
Half-life the time taken for the radioactivity (decay activity) of a specific isotope to half. Decay of individual atoms is probabilistic and not predictable, but for a large group of atoms of the same isotope the probability is equal and so the decay rate can be approximated and the half-life calculated.
Decay, Radioactive decay—a process in which an unstable atomic nucleus loses energy by radiation, typically emitting a particle such as an alpha particle, beta particle or gamma ray. In the case of alpha and beta particle emission, the decay is a nuclear transmutation event of the parent atom to a daughter atom of a different isotope.
Decay chain—a predictable series of isotopes produced by the sequential radioactive decays of a specific isotope, and the decay of its daughter products.
Element—substances that cannot be chemically interconverted or broken down into simpler substances and are the primary constituents of all matter, distinguished by their atomic number.
Atomic Number—the number of protons in the nucleus of an atom, which determines the chemical properties of an element and its place in the periodic table.
Alpha particle—a helium nucleus emitted during Alpha decay, a form of nuclear decay.
Beta particle—a fast-moving electron emitted by in Beta decay, a form of nuclear decay
Surface Plasmon Resonance (SPR)—a physical phenomenon whereby photons of light travelling across a conductive material resonate with the charge carriers in the material, generating large electric fields

### Protection of Variations

In the drawings, like numerals indicate like elements throughout. Certain terminology is used herein for convenience only and is not to be taken as a limitation on the present disclosure. The terminology includes the words specifically mentioned, derivatives thereof and words of similar import. The embodiments illustrated below are not intended to be exhaustive or to limit the disclosure to the precise form disclosed. These embodiments are chosen and described to best explain the principle of the disclosure and its application and practical use and to enable others skilled in the art to best utilize the disclosure.

The present disclosure can be understood more readily by reference to the instant detailed description, examples, and claims. It is to be understood that this disclosure is not limited to the specific systems, devices, and/or methods disclosed unless otherwise specified, as such can, of course, vary. It is also to be understood that the terminology used herein is for the purpose of describing particular aspects only and is not intended to be limiting.

The instant description of the disclosure is provided as an enabling teaching of the disclosure in its best, currently known aspect. Those skilled in the relevant art will recognize that many changes can be made to the aspects described, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

In one exemplary embodiment, a radioisotope generator is provided, including a laser, a volume of a target isotope in a solid or liquid solution state, and, nanoparticles or nanostructures in a solid, liquid or gas state. The laser can be operated within the wavelength range of 400 nm-2500 nm. The target isotope can be one of. Uranium-233; Uranium-235; Uranium-238; Thorium-228; Thorium-229, Thorium-232; Americium-241; Neptunium-237. The nanoparticles can be in a solution with concentrations ranging from 0.001 milligrams per milliliter up to 10 milligrams per milliliter. The nanoparticles or nanostructures can be made of a single element or mixtures of elements including: gold, platinum, silicon, silicon dioxide, silver, aluminum, nickel, copper, CuO, TiO2, and cobalt. The intensity (power per unit area) of the laser can be above 108 W/cm2 (Watts per square centimeter). The intensity (power per unit area) of the laser beam can be increased above 108 W/cm2 using optics such as lenses.

In another exemplary embodiment, a method of producing an isotope is provided including providing a radioisotope generator, with the radioisotope generator including a laser, a volume of a target isotope in a solid or liquid solution state, and nanoparticles or nanostructures in a solid, liquid, or gas state. The method further includes operating the laser at 100 nm to 1 mm wavelength to produce a daughter isotope from the target isotope. Additionally, the method can produce isotopes for use in pharmaceutical applications including: imaging; targeted alpha therapy; targeted beta therapy. Additionally, the method can include selecting target parent isotopes which decay into daughter product isotopes used for in Radioisotope Thermo-electric Generators (RTGs). Additionally, the method can be used to produce isotopes for use in industrial and scientific applications by selecting target parent isotopes which decay into daughter product isotopes used in non-medical applications.

In another exemplary embodiment, a method of generating electrical power from the decay process induced and accelerated by a radioisotope generator is provided that includes converting the radiation or heat released in during the decay process to usable energy by means of common thermal power generation or photovoltaic methods. Here, the radioisotope generator is provided, including a laser, a volume of a target isotope in a solid or liquid solution state, and, nanoparticles or nanostructures in a solid, liquid or gas state. The laser can be operated within the wavelength range of 400 nm-2500 nm. The target isotope can be one of: Uranium-233; Uranium-235, Uranium-238, Thorium-228; Thorium-229: Thorium-232, Americium-241, Neptunium-237. The nanoparticles can be in a solution with concentrations ranging from 0.001 milligrams per milliliter up to 10 milligrams per milliliter. The nanoparticles or nanostructures can be made of a single element or mixtures of elements including: gold, platinum, silicon, silicon dioxide, silver, aluminum, nickel, copper, CuO, TiO2, and cobalt. The intensity (power per unit area) of the laser can be above 108 W/cm2 (Watts per square centimeter). The intensity (power per unit area) of the laser beam can be increased above 108 W/cm2 using optics such as lenses.

In another exemplary embodiment, a method of transmuting hazardous, radioactive nuclear waste into stable, less hazardous waste using a radioisotope generator by using the radioactive material as a target isotope and producing daughter isotopes that may not be a product of value is provided. Here, the radioisotope generator is provided, including a laser, a volume of a target isotope in a solid or liquid solution state, and, nanoparticles or nanostructures in a solid, liquid or gas state. The laser can be operated within the wavelength range of 400 nm 2500 nm. The target isotope can be one of: Uranium-233: Uranium-235: Uranium-238; Thorium-228; Thorium-229; Thorium-232; Americium-241: Neptunium-237. The nanoparticles can be in a solution with concentrations ranging from 0.001 milligrams per milliliter up to 10 milligrams per milliliter. The nanoparticles or nanostructures can be made of a single element or mixtures of elements including: gold, platinum, silicon, silicon dioxide, silver, aluminum, nickel, copper, CuO, TiO2, and cobalt. The intensity (power per unit area) of the laser can be above 108 W/cm2 (Watts per square centimeter). The intensity (power per unit area) of the laser beam can be increased above 108 W/cm2 using optics such as lenses.

As used herein, the singular forms “a,” “an” and “the” include plural referents unless the context clearly dictates otherwise. Thus, for example, reference to a “body” includes aspects having two or more bodies unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects of the invention have been disclosed in the foregoing specification, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

1. A radioisotope generator comprising:
a laser,
a volume of a target isotope in a solid or liquid solution state; and,
nanoparticles or nanostructures in a solid, liquid or gas state.

2. The radioisotope generator of claim 1, wherein the laser is operated within the wavelength range of 400 nm-2500 nm.

3. The radioisotope generator of claim 1, wherein the target isotope is one of: Uranium-233; Uranium-235; Uranium-238; Thorium-228; Thorium-229; Thorium-232; Americium-241; Neptunium-237.

4. The radioisotope generator of claim 1, wherein the nanoparticles are in a solution with concentrations ranging from 0.001 milligrams per milliliter up to 10 milligrams per milliliter.

5. The radioisotope generator of claim 1, wherein the nanoparticles or nanostructures are made of a single element or mixtures of elements including: gold, platinum, silicon, silicon dioxide, silver, aluminum, nickel, copper, CuO, TiO2, and cobalt.

6. The radioisotope generator of claim 1, wherein the intensity (power per unit area) of the laser is at a low power density above 10\hat{ }8 W/cm2 (Watts per square centimeter).

7. The radioisotope generator of claim 1, wherein the intensity (power per unit area) of the laser beam is increased above 108 W/cm2 using optics such as lenses.

8. A method of producing an isotope comprising:
providing a radioisotope generator; wherein the radioisotope generator comprises a laser, a volume of a target isotope in a solid or liquid solution state, and nanoparticles or nanostructures in a solid, liquid, or gas state; and,
operating the laser at 100 nm to 1 mm wavelength to produce a daughter isotope from the target isotope.

9. The method of claim 8 to produce isotopes for use in pharmaceutical applications including: imaging; targeted alpha therapy; targeted beta therapy.

10. The method of claim 8 further comprising selecting target parent isotopes which decay into daughter product isotopes used for in Radioisotope Thermo-electric Generators (RTGs).

11. The method of claim 8 used to produce isotopes for use in industrial and scientific applications by selecting target parent isotopes which decay into daughter product isotopes used in non-medical applications.

12. A method of generating electrical power from the decay process induced and accelerated by the radioisotope generator of claim 1 by converting the radiation or heat released in during the decay process to usable energy by means of common thermal power generation or photovoltaic methods.

13. A method of transmuting hazardous, radioactive nuclear waste into stable, less hazardous waste using the radioisotope generator of claim 1 by using the radioactive material as a target isotope and producing daughter isotopes that may not be a product of value.

14. The radioisotope generator of claim 1 wherein the nanoparticles are of uniform size.

15. The radioisotope generator of claim 14 wherein the nanoparticles are generated by a process other than laser ablation.

16. The radioisotope generator of claim 6 wherein the radioisotope generator operates under 10\hat{ }11 W/cm2.

17. The radioisotope generator of claim 1 wherein the volume of the target isotope is in the liquid state and the volume is circulated to prevent continuous irradiation of sections of the volume.

18. The radioisotope generator of claim 1 wherein the volume of the target isotope is in the liquid state and the volume is circulated to limit irradiation time to avoid destroying useful isotopes generated.
